(19) United States
(12) Patent Application Publication
(10) Pub. No.: US 2013/0025724 A1
(43) Pub. Date: Jan. 31, 2013

(54) EXCESS FLOW VALVE

(71) Applicants: James J. Grebinoski, Export, PA (US); Michael Angus, Derry, PA (US); Mark Felgar, New Stanton, PA (US); David P. Yankes, Monroeville, PA (US)

(72) Inventors: James J. Grebinoski, Export, PA (US); Michael Angus, Derry, PA (US); Mark Felgar, New Stanton, PA (US); David P. Yankes, Monroeville, PA (US)

(73) Assignee: WATTS WATER TECHNOLOGIES, INC., North Andover, MA (US)

(21) Appl. No.: 13/193,218

(22) Filed: Jul. 28, 2011

(51) Int. Cl. F16K 15/14

(52) U.S. Cl. 137/843; 137/455

(57) ABSTRACT

An excess flow valve including: (a) a housing including: an inlet portion; and ii) an outlet portion coupled to the inlet portion to define an interior having a passageway between an inlet and an outlet, wherein at least one of the inlet and outlet portion defines a valve seat and an annular channel; and (b) a unitary plunger including: a valve portion defining an aperture; a rim surrounding the valve portion; and an expandable portion extending between the valve portion and the rim, wherein the rim seats within the annular channel to fix the plunger such that the valve portion is set apart from the valve seat for allowing the passageway to be normally open, and as a flow through the fluid passageway exceeds a predetermined level, the expandable portion extends so that the valve portion couples to the valve seat to at least partially close the passageway.

### TECHNICAL FIELD OF THE DISCLOSURE

The present disclosure relates to fluid systems with excess flow valves and, more particularly, to excess flow valves that automatically stop or limit delivery of a fluid from a supply when a portion of the fluid system is severed, ruptured, or disconnected.

### BACKGROUND OF THE DISCLOSURE

In many fluid systems, delivery lines remain under pressure and periodically provide flow to the point of use. However, if a delivery line becomes severed, ruptured, or disconnected, it would be advantageous to have flow through the line either cut off or reduced as much as possible. For example, if a delivery line carrying natural gas to a stove were to sever, rupture, or disconnect, the resulting flow of natural gas is an immediate hazard. Dishwashers, dryers, heating systems, washing machines and other residential applications can benefit from such cut off valves. Further, many industrial applications such as rock drilling, the semiconductor industry, the aviation industry or the like often deploy cut off valves for safety and to preserve equipment.

In view of the above, cut off valves have been developed such as: U.S. Pat. No. 2,917,077, issued on Dec. 15, 1953, entitled “Excess Flow Check Valve”; U.S. Pat. No. 3,910,306, issued on Oct. 7, 1975, entitled “Safety Cut-off Valve”; U.S. Pat. No. 3,872,884, issued on Mar. 25, 1975, entitled “Excess Flow Check Valve”; U.S. Pat. No. 3,735,777, issued on May 29, 1973, entitled “Automatic Valve”; and U.S. Pat. No. 3,794,077, issued on Feb. 26, 1974, entitled “Excess Flow Check Valve.”

### SUMMARY OF THE DISCLOSURE

There are problems associated with prior art shut-off valves. Typical designs are complex and performance may vary greatly from device to device. Further, as design complexity increases, the cost may become impractical.

It is an object of the subject technology to provide a new and improved excess flow valve. The excess flow valve can work with a variety of fluids (e.g., liquid or gas) in virtually any application. Particularly, the excess flow valve is well suited to natural gas, propane, and liquefied petroleum (LP) gas applications.

In one embodiment, the subject technology is directed to an excess flow valve for use in a fluid network including a housing defining an interior creating a fluid passageway between an inlet and an outlet. The housing also has a valve seat. A plunger, within the interior, has a valve portion surrounded by a rim with an expandable portion extending between the valve portion and the rim. The plunger is normally biased by the expandable portion so that the valve portion is in an open position set apart from the valve seat, i.e., the fluid passageway through the excess flow valve is open. As flow through the interior exceeds a predetermined level, the expandable portion expands so that the valve portion couples to the valve seat creating a closed position in which the fluid passageway through the excess flow valve is closed. Preferably, the expandable portion of the plunger defines at least one slot and has at least one flexible land. The plunger may be fabricated from a flexible non-metallic material in a molding process.

Another embodiment of the subject technology is directed to a valve for reducing flow in a fluid network based upon a predetermined condition. The valve includes a housing having an inlet portion that couples to an outlet portion to define an interior. A fluid passageway extends between an inlet and an outlet of the housing, wherein at least one of the inlet and outlet portion defines a valve seat and an annular channel. A plunger has a valve portion surrounded by a rim with an expandable portion extending between the valve portion and the rim. The rim seats within the annular channel to fix the plunger in the interior such that the valve portion is set apart from the valve seat for allowing the fluid passageway to be normally open. As a flow through the interior exceeds a predetermined level, the expandable portion expands so that the valve portion couples to the valve seat creating a closed position in which the fluid passageway through the excess flow valve is at least partially closed.

The flow may be in a reverse direction as compared with a primary flow and flow is substantially closed in the closed position such that the valve acts as a cheek valve. Preferably, the valve portion is substantially a cone shape truncated by a flat end and the valve seat has a complimentary shape to the valve portion so that upon the valve portion extending against the housing valve seat, a seal forms therebetween to block the fluid passageway. The rim can act as a seal between the inlet and outlet portions.

In still another embodiment, the subject technology is directed to an excess flow valve including: (a) a housing including: i) an inlet portion; and ii) an outlet portion coupled to the inlet portion to define an interior having a fluid passageway between an inlet and an outlet, wherein at least one of the inlet and outlet portion defines a valve seat and an annular channel; and (b) a unitary plunger including: i) a cone-shaped valve portion truncated by a flat end that defines an aperture; ii) a rim surrounding the valve portion; and iii) an expandable portion extending between the valve portion and the rim, wherein the rim seats within the annular channel to fix the plunger in the interior such that the valve portion is set apart from the valve seat for allowing the fluid passageway to be normally open, and as a flow through the fluid passageway exceeds a predetermined level, the expandable portion extends so that the valve portion couples to the valve seat creating a closed position in which the fluid passageway through the excess flow valve is at least partially closed.

It should be appreciated that the present invention can be implemented and utilized in numerous ways, including without limitation as a process, an apparatus, a system, a device, and a method for applications now known and later developed. These and other unique features of the system disclosed herein will become more readily apparent from the following description and the accompanying drawings.

### BRIEF DESCRIPTION OF DRAWINGS

Reference is made to the attached drawings, wherein elements having the same reference character designations represent like elements throughout.

FIG. 1 is a perspective exploded view of an excess flow valve in accordance with the subject disclosure.

FIG. 2 is a perspective cross-sectional view of the excess flow valve of FIG. 1.

FIG. 3 is an isolated perspective view of a plunger of the excess flow valve of FIG. 1.

FIG. 4 is a side view of the plunger of FIG. 3.

FIG. 5 is a top view of the plunger of FIG. 3.

FIG. 6 is another cross-sectional view of the excess flow valve of FIG. 1 with the plunger in the open position to allow fluid to flow through the excess flow valve.

FIG. 7 is another cross-sectional view of the excess flow valve of FIG. 1 with the plunger in the closed position to block fluid to flow through the excess flow valve.

### DETAILED DESCRIPTION OF PREFERRED EMBODIMENTS

The present disclosure overcomes many of the prior art problems associated with excess flow valves. The advantages, and other features of the technology disclosed herein, will become more readily apparent to those having ordinary skill in the art from the following detailed description of certain preferred embodiments taken in conjunction with the drawings which set forth representative embodiments of the present invention and wherein like reference numerals identify similar structural elements.

All relative descriptions herein such as left, right, up, and down are with reference to the Figures, and not meant in a limiting sense. Unless otherwise specified, the illustrated embodiments can be understood as providing exemplary features of varying detail of certain embodiments, and therefore, unless otherwise specified, features, components, modules, elements, and/or aspects of the illustrations can be otherwise combined, interconnected, sequenced, separated, interchanged, positioned, and/or rearranged without materially departing from the disclosed systems or methods. Additionally, the shapes and sizes of components are also exemplary and can be altered without materially affecting or limiting the disclosed technology.

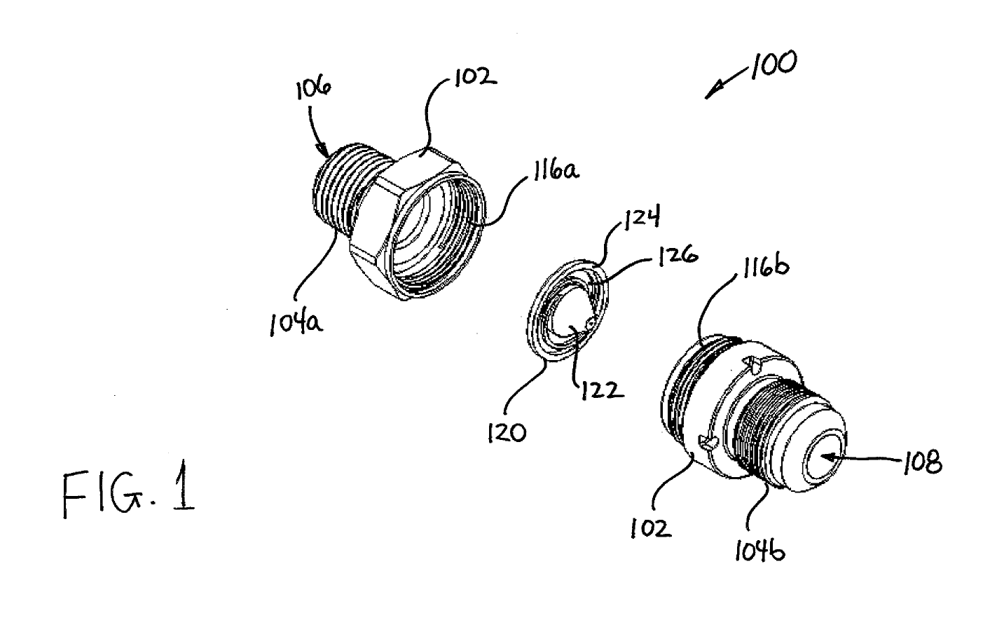

Referring to FIG. 1, a perspective view of an excess flow valve 100 in accordance with the subject disclosure for use in a fluid network (not shown) is shown. The excess flow valve 100 has a housing 102 formed by two mating portions 104a, 104b. The first housing portion 104a defines an inlet 106 for connecting to the fluid network. The second housing portion 104b defines an outlet 108 also for connecting to the fluid network. It is envisioned that the housing 102 could be adapted, reconfigured, and rearranged for inclusion in any desired network. As shown, the inlet 106 and the outlet 108 are simply threaded to engage a traditional fitting.

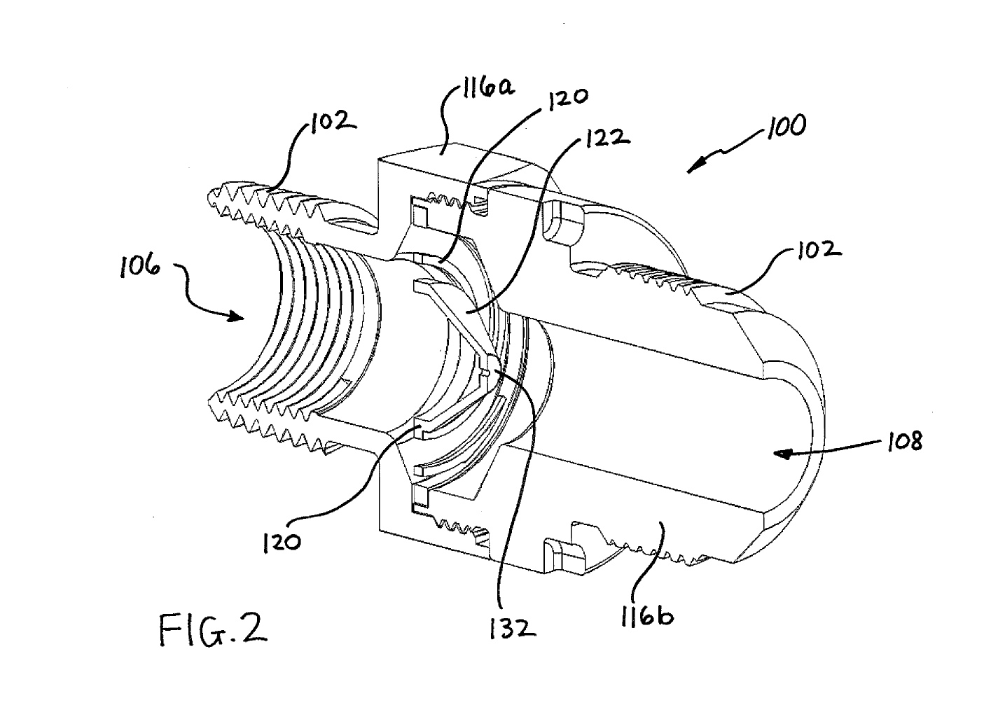

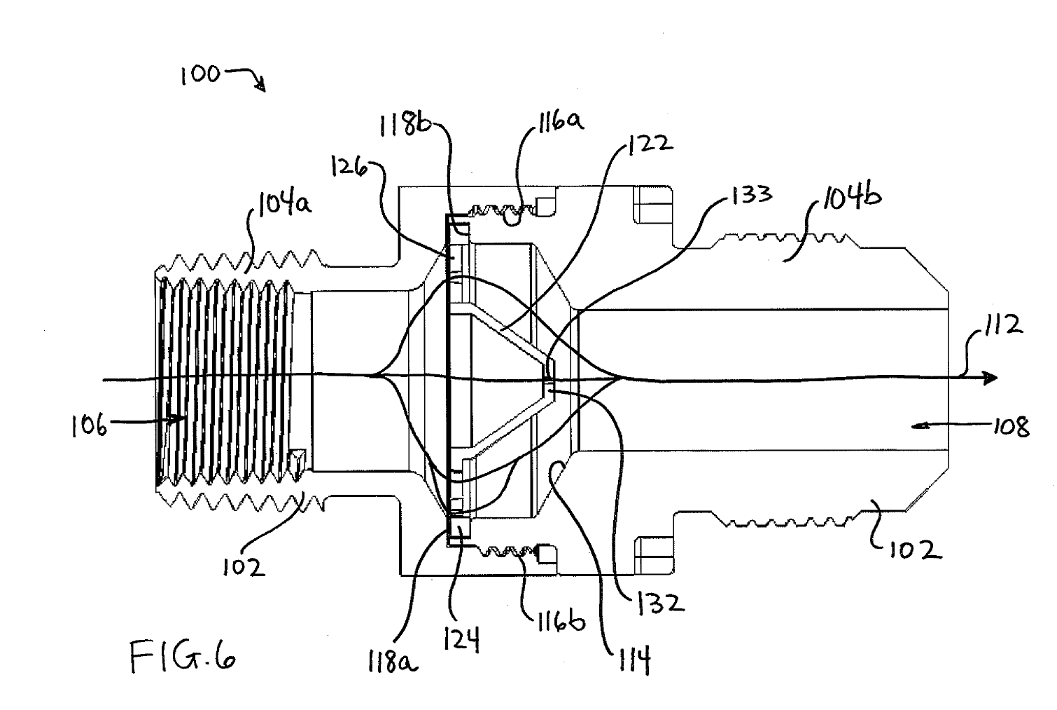

Referring additionally to FIG. 2, a perspective cross-sectional view of the excess flow valve 100 is shown. When the housing portions 104a, 104b are mated together, the housing 102 defines an interior 110 having a fluid passageway 112 (best seen in FIG. 6) between the inlet 106 and the outlet 108. A plunger 120 couples within the interior 110 so that as flow through the interior 110 exceeds a predetermined level, the plunger 120 moves from an open position to a closed position in which the fluid passageway 112 through the excess flow valve 100 is closed as is described below in more detail.

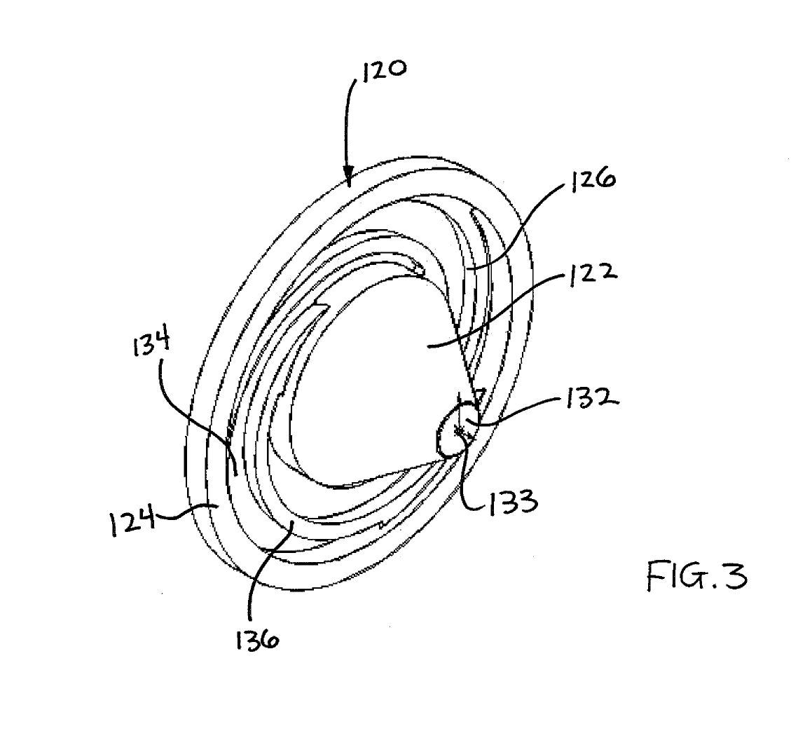

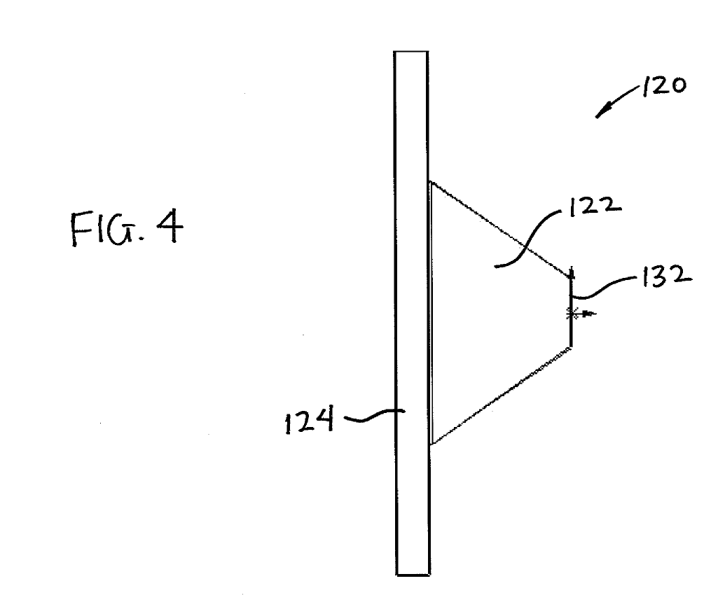

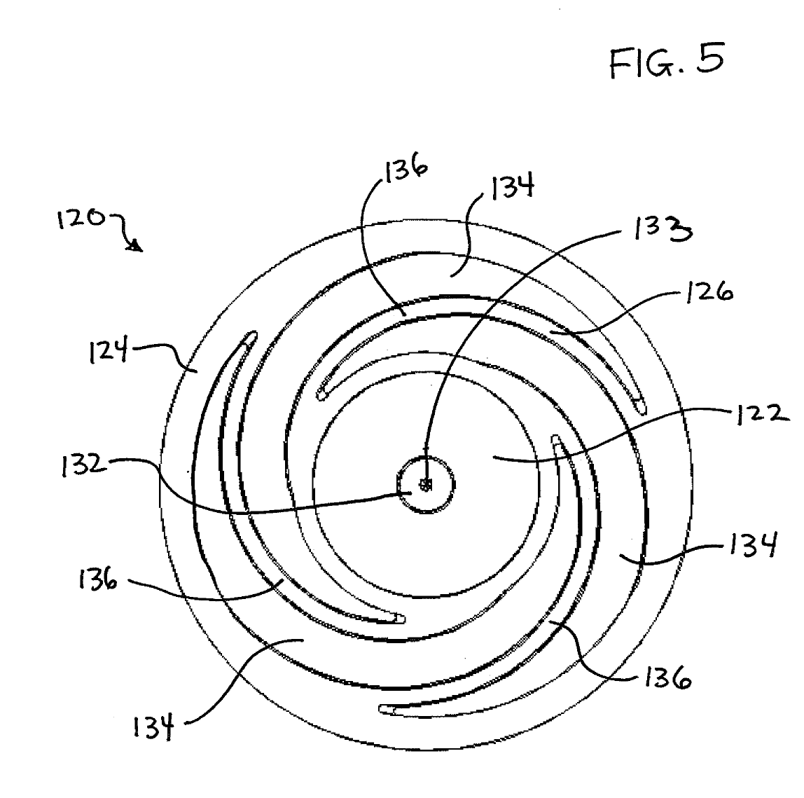

Referring now to FIGS. 3-5, various isolated view of the plunger 120 are shown. In one embodiment, the plunger 120 is fabricated from a molded thermoplastic elastomer or rubber such as ALCRYN® rubber available from Advanced Polymer Alloys of Wilmington, Del.. The plunger 120 may also be fabricated from hydrogenated nitrile butadiene rubber (HNBR) and/or a fluorocarbon elastomer such as VITON® elastomer available from E.I. du Pont de Nemours and Company of Wilmington, Delaware. Preferably, the plunger 120 is a single piece as shown however, the plunger 120 may be separate components that are subsequently joined or coupled together as would be appreciated by one of ordinary skill in the art based upon review of the subject disclosure.

The plunger 120 has a valve portion 122 surrounded by a rim 124 with an expandable portion 126 extending between the valve portion 122 and the rim 124. The valve portion 122 is substantially a cone shape truncated by a flat end 132. The flat end 132 may include an aperture 133 that allows some level of residual flow even in the closed position. The valve portion 122 may be frusto-conical, bulbous, oblong and the like in shape. The housing 102 defines a complimentary shaped valve seat 114 (best seen in FIG. 6) so that upon the valve portion 122 extending against the housing valve seat 114, a seal forms therebetween to block the fluid passageway 112.

The expandable portion 126 of the plunger 120 includes at least one slot 134 for allowing fluid flow. In the preferred embodiment shown, the expandable portion 126 forms three, crescent shaped slots 134 with flexible lands 136 between the slots 134. The at least one slot 134 could be any configuration such as a spiral slot, four arcuate slots, or combinations thereof and the like. As a result of the slots 134, the expandable portion 126 is flexible enough to extend or expand in response to pressure changes against the valve portion 122. The normal position for the valve portion 122 is not extended as shown in FIGS. 3-5.

In an alternative embodiment, the expandable portion does not include any slots but rather is simply configured to expand. For example, the expandable portion may be thin enough and/or fabricated from a flexible enough material to stretch when subjected to the predetermined pressure. The expandable portion may be fabricated separately or from a different material to provide the desired elastic properties.

Referring again to FIGS. 1 and 2, in order to assemble the excess flow valve 100, the inlet and outlet portions 104a, 104b have threaded inner ends 116a, 116b that sealingly couple together. The inlet portion 104a forms a shoulder 118a that cooperates with a hollow 118b formed in the outlet portion 104b to result in the formation of an annular channel 119. When assembled, the rim 124 is captured in the annular channel 119 so that the position of the plunger 120 is fixed within the interior 110. The rim 124 may be configured to act as a seal between the inlet and outlet portions 104a, 104b.

Referring now to FIG. 6, a cross-sectional view of the excess flow valve 100 with the plunger 120 in the open position to allow fluid to flow through the excess flow valve 100 is shown. In the normal condition (e.g., without forces acting upon the plunger 120), the passageway 112 is open. The passageway 112 extends through the inlet 106, the slots 134, the aperture 133, and the outlet 108. Because the valve portion 122 of the plunger 120 is not extended, fluid can easily pass between the valve portion 122 and the valve seat 114 of the housing outlet portion 104b.

As fluid enters the inlet 106, the flow will interact with the back side of the plunger 120. Although this resulting pressure can cause the valve portion 122 to extend towards the valve seat 114, a limited amount of movement will not close the passageway 112 because the valve portion 122 is set apart from the valve seat 114. The material, size and shape of the flexible lands 136 will largely determine how much and how easily the valve portion 122 extends outward from the rim 124.

In view of the above, the material that the plunger 120 and particularly the expandable area 126 is created from along with the size and shape of the plunger 120 plus the configuration of the slots 134 and the lands 136 as well as the aperture 133 can be selected to determine the performance characteristics of the excess flow valve 100. The design of the excess flow valve 100 is configured to move to the closed position based upon a predetermined value. For example, without being limited, a thickness of the lands 136 may be increased, the number and size of slots 134 may be decreased, as well as the aperture 133 reduced to raise the flow rate and/or pressure at which the valve portion 122 will extend to the valve seat 114. The size of the valve portion 122 may also be varied. The expandable portion 126 may also be a different material and manufactured separately from the remainder of the plunger 120. The location of the annular channel 119 relative to the valve seat 114 may also be modified as to affect the flow rate and/or pressure at which the valve portion 122 will extend to the valve seat 114.

For an example of performance, in a typical residential application for a delivery line carrying natural gas, normal flow and pressure might be 100,000 Btu/hr at 6 in w.c. A break in the delivery line may cause flow to increase to amounts greater than 250,000 Btu/hr. Accordingly, for a residential natural gas application, the excess flow valve 100 would be designed and configured to close at about 220,000 Btu/hr.

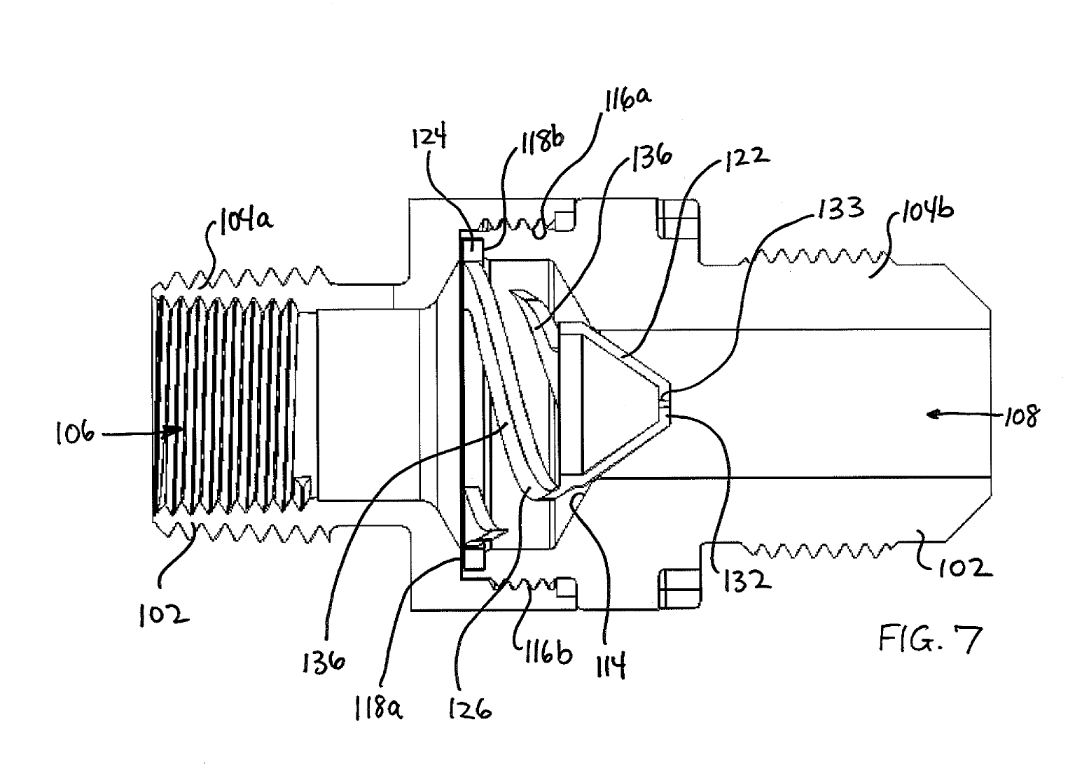

Referring now to FIG. 7, a cross-sectional view of the excess flow valve 100 with the plunger 120 in the closed position to block fluid to flow is shown. As can be seen, the expandable portion 126 extends from the pressure and/or flow increase so that the valve portion 122 seats or couples to the valve seat 114 to block the fluid passageway 112, i.e., the closed position. It is envisioned that the aperture 133 in the flat end 132 of the plunger 120 maintains a residual pathway open even in the closed position. The valve portion 122 or valve seat 114 can also be configured to maintain residual flow such as by including axial grooves or simply mismatching the complimentary profiles and the like. In an alternative embodiment, the valve portion 122 seals against the valve seat 114 and no aperture 133 is present so that the excess flow valve acts to completely stop flow.

It is also envisioned that the subject technology can be utilized as a check valve. For example, the expandable portion 126 could also move to the left under reverse flow in FIGS. 6 and 7. The plunger 120 can have a secondary valve portion or the shown valve portion 122 could be reversed so that the valve 100 acts only as a check valve. The housing 102 would define a complimentary valve seat opposing the valve seat 114 to sealingly couple with the plunger 120 to block off reverse flow (e.g., flow from right to left as shown in FIGS. 6 and 7).

Still further, the slot or slots 134 could be so thin that the lands seal together when no force is exerted. Upon exertion of a predetermined pressure, the lands would separate creating slits for fluid passage. Hence, a minimal pressure and/or flow can be set prior to the valve opening. If such a structure is incorporated within a design similar to the first embodiment above, then the result is a valve that allows flow over a predetermined range.

### Incorporation by Reference

All patents, published patent applications and other references disclosed herein are hereby expressly incorporated in their entireties by reference.

While the invention has been described with respect to preferred embodiments, those skilled in the art will readily appreciate that various changes and/or modifications can be made to the invention without departing from the spirit or scope of the invention as defined by the appended claims. For example, each claim may depend from any or all claims in a multiple dependent manner even though such has not been originally claimed.

What is claimed is:

1. An excess flow valve for use in a fluid network comprising:
a housing defining an interior creating a fluid passageway between an inlet and an outlet, the housing having a valve seat; and
a plunger, within the interior, having a valve portion surrounded by a rim with an expandable portion extending between the valve portion and the rim, the plunger being normally biased by the expandable portion so that the valve portion is in an open position set apart from the valve seat in which the fluid passageway through the excess flow valve is open,
wherein as flow through the interior exceeds a predetermined level, the expandable portion expands so that the valve portion couples to the valve seat creating a closed position in which the fluid passageway through the excess flow valve is closed.

2. An excess flow valve as recited in claim 1, wherein the expandable portion of the plunger defines at least one slot.

3. An excess flow valve as recited in claim 2, wherein the at least one slot is three, crescent shaped slots with flexible lands between the slots.

4. An excess flow valve as recited in claim 1, wherein the plunger is fabricated from an elastomer in a mold process and the valve portion includes an aperture for residual flow.

5. An excess flow valve as recited in claim 1, wherein the valve portion is substantially a cone shape truncated by a flat end and the housing valve seat has a complimentary shape to the valve portion so that upon the valve portion extending against the housing valve seat, a seal forms there between to block the fluid passageway.

6. An excess flow valve as recited in claim 1, wherein the housing includes an inlet portion that couples to an outlet portion.

7. An excess flow valve as recited in claim 6, wherein the inlet portion forms a shoulder that cooperates with a hollow formed in the outlet portion to result in the formation of an annular channel that captures the rim to fix a position of the plunger within the interior.

8. An excess flow valve as recited in claim 7, wherein the rim acts as a seal between the inlet and outlet portions.

9. A valve for reducing flow in a fluid network based upon a predetermined condition comprising:
a housing including an inlet portion that couples to an outlet portion to define an interior having a fluid passageway between an inlet and an outlet, wherein at least one of the inlet and outlet portion defines a valve seat and an annular channel; and
a plunger having a valve portion surrounded by a rim with an expandable portion extending between the valve portion and the rim, wherein the rim seats within the annular channel to fix the plunger in the interior such that the valve portion is set apart from the valve seat for allowing the fluid passageway to be normally open,
wherein as a flow through the interior exceeds a predetermined level, the expandable portion expands so that the valve portion couples to the valve seat creating a closed position in which the fluid passageway through the excess flow valve is at least partially closed.

10. A valve as recited in claim 9, wherein the flow is in a reverse direction as compared with a primary flow and flow is substantially closed in the closed position such that the valve acts as a check valve.

11. A valve as recited in claim 9, wherein the valve portion defines an aperture for residual flow.

12. A valve as recited in claim 9, wherein the expandable portion of the plunger defines at least one slot as part of the fluid passageway.

13. A valve as recited in claim 12, wherein the at least one slot is three, crescent shaped slots with flexible lands between the slots.

14. A valve as recited in claim 13, wherein the lands seal together when no force is exerted there upon.

15. A valve as recited in claim 9, wherein the plunger is fabricated from an elastomer in a mold process.

16. A valve as recited in claim 9, wherein the valve portion is substantially a cone shape truncated by a flat end and the valve seat has a complimentary shape to the valve portion so that upon the valve portion extending against the housing valve seat, a seal forms therebetween to block the fluid passageway.

17. A flow valve as recited in claim 9, wherein the inlet portion forms a shoulder that cooperates with a hollow formed in the outlet portion to result in the formation of an annular channel that captures the rim to fix a position of the plunger within the interior.

18. An excess flow valve as recited in claim 9, wherein the rim acts as a seal between the inlet and outlet portions.

19. An excess flow valve comprising:
(a) a housing including: i) an inlet portion; and ii) an outlet portion coupled to the inlet portion to define an interior having a fluid passageway between an inlet and an outlet, wherein at least one of the inlet and outlet portion defines a valve seat and an annular channel; and
(b) a unitary plunger including: i) a cone-shaped valve portion truncated by a flat end that defines an aperture; ii) a rim surrounding the valve portion; and iii) an expandable portion extending between the valve portion and the rim,
wherein the rim seats within the annular channel to fix the plunger in the interior such that the valve portion is set apart from the valve seat for allowing the fluid passageway to be normally open, and
as a flow through the fluid passageway exceeds a predetermined level, the expandable portion extends so that the valve portion couples to the valve seat creating a closed position in which the fluid passageway through the excess flow valve is at least partially closed.

20. An excess flow valve as recited in claim 19, wherein the valve portion and the valve seat have complimentary shapes and the expandable portion defines at least one slot as a portion of the fluid passageway.
